(19) United States
(12) Patent Application Publication
(10) Pub. No.: US 2023/0289397 A1
(43) Pub. Date: Sep. 14, 2023

(54) FAST FOURIER TRANSFORM DEVICE, DIGITAL FILTERING DEVICE, FAST FOURIER TRANSFORM METHOD, AND NON-TRANSITORY COMPUTER-READABLE MEDIUM

(71) Applicant: NEC Corporation, Tokyo (JP)

(72) Inventor: Atsufumi SHIBAYAMA, Tokyo (JP)

(73) Assignee: NEC Corporation, Tokyo (JP)

(21) Appl. No.: 18/118,459

(22) Filed: Mar. 7, 2023

(30) Foreign Application Priority Data
Mar. 10, 2022 (JP) 2022-036908

(51) Int. Cl. G06F 17/14; G06F 7/24; G06F 7/523

(52) U.S. Cl. CPC G06F 17/142; G06F 7/24; G06F 7/523

(57) ABSTRACT

When performing a fast Fourier transform or an inverse fast Fourier transform in M cycles on input data in units of N consecutive input data, an FFT device, in F fast Fourier transforms or F inverse fast Fourier transforms, sorts (F×N) first input data in a first order to output first output data in a second order, performs a butterfly computation process on the first output data to output second output data in the first order, sorts the second output data to output third output data in a third order, and performs a twiddle multiplication process on the third output data to output fourth output data in the third order, and the third order is an order in which processes of the Cth cycle in the F fast Fourier transforms or the F inverse fast Fourier transforms are performed in a consecutive cycle.

### INCORPORATION BY REFERENCE

This application is based upon and claims the benefit of priority from Japanese patent application No. 2022-036908, filed on Mar. 10, 2022, the disclosure of which is incorporated herein in its entirety by reference.

### TECHNICAL FIELD

The present disclosure relates to digital filtering devices that perform digital signal processing and relates, in particular, to a fast Fourier transform device, a fast Fourier transform method, and a program.

### BACKGROUND ART

Fast Fourier transform (referred to below as FFT) is one of the important processes in digital signal processing. Frequency domain equalization (FDE), for example, is known as a technique for compensating for waveform distortion that occurs in signal transmission in wireless communication or in wired communication. In frequency domain equalization, first, signal data in the time domain is transformed into data in the frequency domain through a fast Fourier transform, and then a filtering process for equalization is performed. The data resulting from the filtering process is then retransformed into signal data in the time domain through an inverse FFT (referred to below as IFFT), and thus any waveform distortion in the original signal in the time domain is compensated for. In the following, FFT and IFFT are indicated as FFT/IFFT, when no distinction is made between FFT and IFFT.

Typically, butterfly computation is used in an FFT/IFFT process. An FFT device that uses butterfly computation is described, for example, in Japanese Unexamined Patent Application Publication No. H08-137832. Japanese Unexamined Patent Application Publication No. H08-137832 also describes twiddle multiplication (described later), or specifically, describes multiplication that uses a twiddle coefficient.

The Cooley-Tukey butterfly computation described in J. W. Cooley and J. W. Tukey, “An Algorithm for the Machine Calculation of Complex Fourier Series,” Mathematics of Computation, US, American Mathematical Society, April 1965, Vol. 19, No. 90, pp. 297-301, for example, is well-known as an efficient FFT/IFFT processing method. However, the Cooley-Tukey FFT/IFFT with a large number of points requires a complex circuit. Therefore, a single process is broken down into two smaller FFTs/IFFTs with use of, for example, the prime factor method described in D. P. Kolba, “A Prime Factor FFT Algorithm Using High-Speed Convolution,” IEEE Trans. on Acoustics, US, IEEE Signal Processing Society, August 1977, Vol. 29, No. 4, pp. 281-294, and then the FFT/IFFT processes are performed.

FIG. 14 shows a data flow 500 of a 64-point FFT that has been broken down into a two-stage radix-8 butterfly process with use of, for example, the prime factor method. The data flow 500 includes a data sorting process 501, a radix-8 butterfly computation process that includes a total of eight instances each of butterfly computation processes 502 and 503, and a twiddle multiplication process 504.

In the data flow shown in FIG. 14, input time-domain data x(n) (n=0, 1, . . . , 63) is Fourier-transformed into a frequency-domain signal X(k) (k=0, 1, . . . , 63) through an FFT process. FIG. 14 omits part of the data flow. Herein, the basic configuration of the data flow shown in FIG. 14 applies in the same way when an IFFT process is performed.

Implementing the entire data flow shown in FIG. 14 with a circuit requires a massive-scale circuit. Therefore, in a typical method, circuits that implement part of the processes in the data flow are used repetitively depending on the required processing performance, and thus the entire FFT process is implemented.

For example, in the data flow shown in FIG. 14, if an FFT device that performs an FFT process on eight data items in parallel (simply referred to below as “eight data items in parallel”) is created in the form of a physical circuit, a 64-point FFT process can be implemented through a total of eight repetitive processes.

In these eight repetitive processes, processes corresponding to respective partial data flows 505a to 505h each performed on eight data items are performed sequentially. Specifically, these processes are performed as follows. The process corresponding to the partial data flow 505a is performed in the first instance, the process corresponding to the partial data flow 505b is performed in the second instance, and the process corresponding to the partial data flow 505c (not shown) is performed in the third instance. Thereafter, the processes are performed in a similar manner sequentially up to the process corresponding to the partial data flow 505h in the eighth instance. With these processes, the 64-point FFT process is implemented.

In butterfly computation, data arranged in a sequential order are read out and processed in an order that follows a predetermined rule. Therefore, data need to be sorted in butterfly computation, and to implement a circuit therefor, mainly a random-access memory (RAM) circuit is used. Japanese Unexamined Patent Application Publication No. 2001-56806, for example, describes an FFT device that sorts data with use of a RAM circuit in butterfly computation. Meanwhile, Japanese Unexamined Patent Application Publication No. 2012-22500, for example, describes an acceleration technique through parallel processing in butterfly computation in an FFT computation device with reduced memory usage. Moreover, Japanese Patent No. 6358096 describes a technique for optimizing the timing and/or the order of outputting processing results of FFT processes to accelerate the process in the stage following the FFT device or to reduce power consumption.

In the data flow of the FFT process shown in FIG. 14, the eight repetitive processes of the respective partial data flows 505a to 505h each performed on eight data items can be executed in any order, and this order determines the order in which the frequency-domain signal X(k) (k=0, 1, . . . , N−1) Fourier-transformed through the FFT process is output or the order of internal arithmetics that implement the FFT process. Meanwhile, part of the power consumed in relation to computation such as a filtering process performed on the signal X(k) or in relation to the internal arithmetics that implement the FFT process is determined by the order in which the signal X(k) is output or the order of the internal arithmetics that implement the FFT process. In other words, in an FFT process, there is a specific order of repetitively executing partial data flows that can reduce the power consumption related to the FFT process, and optimizing the order of execution is effective in reducing the power consumption.

However, none of the FFT circuits described in Non Patent Literatures 1, 2, and 3 concerns optimizing the order of repetitive processes of partial data flows to reduce the power consumption, and there remains a problem of large power consumption.

Japanese Patent No. 6358096 describes an FFT device capable of taking in data to be processed or outputting processing results in a desired order, and this FFT device can output the output X(k) and X(N−k) within a time difference of mere one cycle to accelerate the process in the stage that follows the FFT process. However, Japanese Patent No. 6358096 has no clear description about an optimal configuration for reducing the power consumption, and there remains a problem of large power consumption.

### SUMMARY

An object of the present disclosure is to provide a fast Fourier transform device, a digital filtering device, a fast Fourier transform method, and a program that enable a reduced power-consumption circuit implementing digital signal processing with use of fast Fourier transform.

A fast Fourier transform device according to the present disclosure is a fast Fourier transform device configured to perform, on input time-domain input data, a fast Fourier transform or an inverse fast Fourier transform in M cycles (M is a positive integer of 2 or higher) in units of N consecutive input data (N is a positive integer of 2 or higher), the fast Fourier transform device including:
in F fast Fourier transforms or F inverse fast Fourier transforms (F is a positive integer of 2 or higher) processed consecutively,
first data sorting processing unit configured to sort (F×N) first input data that are input in a first order to output first output data in a second order; butterfly computation processing unit configured to perform a butterfly computation process on the first output data to output second output data in the first order;
second data sorting processing unit configured to sort the second output data to output third output data in a third order; and
twiddle multiplication processing unit configured to perform a twiddle multiplication process by multiplying the third output data by a twiddle coefficient to output fourth output data in the third order,
wherein the third order is an order in which processes of a Cth cycle (C is an integer satisfying 0≤C≤M−1) in the F fast Fourier transforms or the F inverse fast Fourier transforms processed consecutively are performed in a consecutive cycle.

A fast Fourier transform method according to the present disclosure is performed by a fast Fourier transform device configured to perform, on input time-domain input data, a fast Fourier transform or an inverse fast Fourier transform in M cycles (M is a positive integer of 2 or higher) in units of N consecutive input data (N is a positive integer of 2 or higher), the fast Fourier transform method including:
in F fast Fourier transforms or F inverse fast Fourier transforms (F is a positive integer of 2 or higher) processed consecutively,
sorting (F×N) first input data that are input in a first order to output first output data in a second order;
performing a butterfly computation process on the first output data to output second output data in the first order;
sorting the second output data to output third output data in a third order; and
performing a twiddle multiplication process by multiplying the third output data by a twiddle coefficient to output fourth output data in the third order,
wherein the third order is an order in which processes of a Cth cycle (C is an integer satisfying 0≤C≤M−1) in the F fast Fourier transforms or the F inverse fast Fourier transforms processed consecutively are performed in a consecutive cycle.

A non-transitory computer-readable medium storing a program according to the present disclosure causes a fast Fourier transform device configured to perform, on input time-domain input data, a fast Fourier transform or an inverse fast Fourier transform in M cycles (M is a positive integer of 2 or higher) in units of N consecutive input data (N is a positive integer of 2 or higher) to execute:
in F fast Fourier transforms or F inverse fast Fourier transforms (F is a positive integer of 2 or higher) processed consecutively,
a process of sorting (F×N) first input data that are input in a first order to output first output data in a second order;
a process of performing a butterfly computation process on the first output data to output second output data in the first order;
a process of sorting the second output data to output third output data in a third order; and
a process of performing a twiddle multiplication process by multiplying the third output data by a twiddle coefficient to output fourth output data in the third order,
wherein the third order is an order in which processes of a Cth cycle (C is an integer satisfying 0≤C≤M−1) in the F fast Fourier transforms or the F inverse fast Fourier transforms processed consecutively are performed in a consecutive cycle.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a fast Fourier transform device 10 according to a first example embodiment;

FIG. 2 is a block diagram illustrating a configuration of a digital filtering device 400 according to a second example embodiment;

FIG. 3 illustrates an array of data sets that follows a sequential order according to the second example embodiment;

FIG. 4 illustrates an array of data sets that follows a bit-reverse order according to the second example embodiment;

FIG. 5 illustrates an order of computation in a radix-8 butterfly computation process according to the second example embodiment;

FIG. 6 illustrates an array of data sets that follows an FFT frame interleave bit-reverse order according to the second example embodiment;

FIG. 7 illustrates an array of twiddle coefficients that follows an FFT frame interleave bit-reverse order according to the second example embodiment;

FIG. 8 illustrates an order of computation in a radix-8 butterfly computation process according to the second example embodiment;

FIG. 9 is a block diagram illustrating a configuration example 100 of a first data sorting processing unit 11 according to the second example embodiment;

FIG. 10 is a block diagram illustrating a configuration example 200 of a second data sorting processing unit 12 according to the second example embodiment;

FIG. 11 illustrates an array of filter coefficients that follows an FFT frame interleave bit-reverse order according to the second example embodiment;

FIG. 12 illustrates an array of data sets that follows an FFT frame interleave power optimization bit-reverse order according to a third example embodiment;

FIG. 13 illustrates an array of twiddle coefficients that follows an FFT frame interleave bit-reverse order according to the third example embodiment; and

FIG. 14 illustrates a data flow 500 of a 64-point FFT process that uses two-stage butterfly computation.

### EXAMPLE EMBODIMENT

Hereinafter, some example embodiments of the present disclosure will be described with reference to the drawings.

### First Example Embodiment

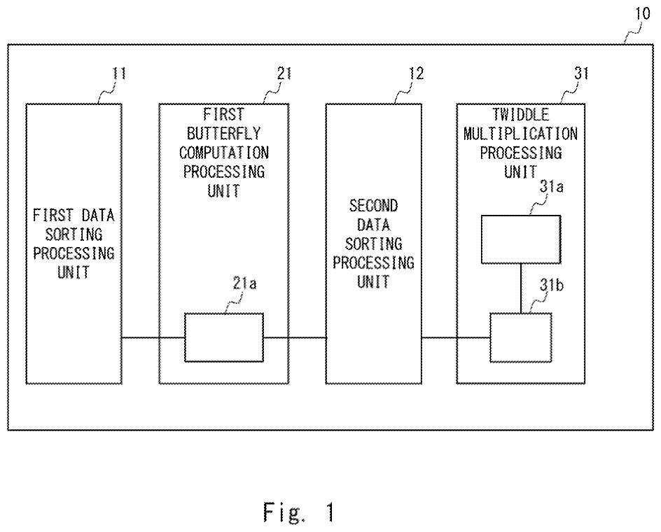

FIG. 1 is a block diagram illustrating an example of a fast Fourier transform device (referred to below as an FFT device) according to a first example embodiment. An FFT device 10 according to the present example embodiment is used for a fast Fourier transform process or an inverse fast Fourier transform process in a digital filtering device. Specifically, the FFT device 10 performs, on input time-domain input data, a fast Fourier transform or an inverse fast Fourier transform in M cycles (M is a positive integer of 2 or higher) in units of N consecutive input data (N is a positive integer of 2 or higher). As illustrated in FIG. 1, the FFT device 10 includes a first data sorting processing unit 11 serving as a first data sorting processing means, a first butterfly computation processing unit 21 serving as a butterfly computation processing means, a second data sorting processing unit 12 serving as a second data sorting processing means, and a twiddle multiplication processing unit 31 serving as a twiddle multiplication processing means. The FFT device 10 performs F consecutive fast Fourier transform processes or F consecutive inverse fast Fourier transform processes (F is a positive integer of 2 or higher).

The first data sorting processing unit 11 sorts (F×N) first input data that are input in a first order and outputs first output data in a second order.

The first butterfly computation processing unit 21 performs a butterfly computation process on the first output data and outputs second output data in the first order.

The second data sorting processing unit 12 sorts the second output data and outputs third output data in a third order.

The twiddle computation processing unit 31 performs a twiddle multiplication process by multiplying the third output data by a twiddle coefficient and outputs fourth output data in the third order.

According to the first example embodiment, the third order is an order in which the processes of the Cth cycle (C is an integer satisfying 0≤C≤M−1) in the F fast Fourier transforms or the F inverse fast Fourier transforms performed consecutively are performed in a consecutive cycle.

With the FFT device 10 according to the first example embodiment described above, the processing order of data input to the twiddle computation processing unit 31 (the third order) can be set to an order in which the processes of the Cth cycle are performed in a consecutive cycle. To rephrase, in a plurality of FFT processes performed consecutively, adopting an interleaved processing order can reduce the power related to a twiddle computation process or a filter computation process. As a result, the power consumption in the entire digital filtering process can be reduced.

While an FFT process is described as an example according to the present example embodiment, the description applies in a similar manner to IFFT as well. Specifically, if the processing order within an IFFT process or in a stage that follows an IFFT process is optimized by applying the control method according to the present example embodiment to an IFFT processing device, the power consumption in the IFFT process or in the stage that follows the IFFT process can be reduced.

### Second Example Embodiment

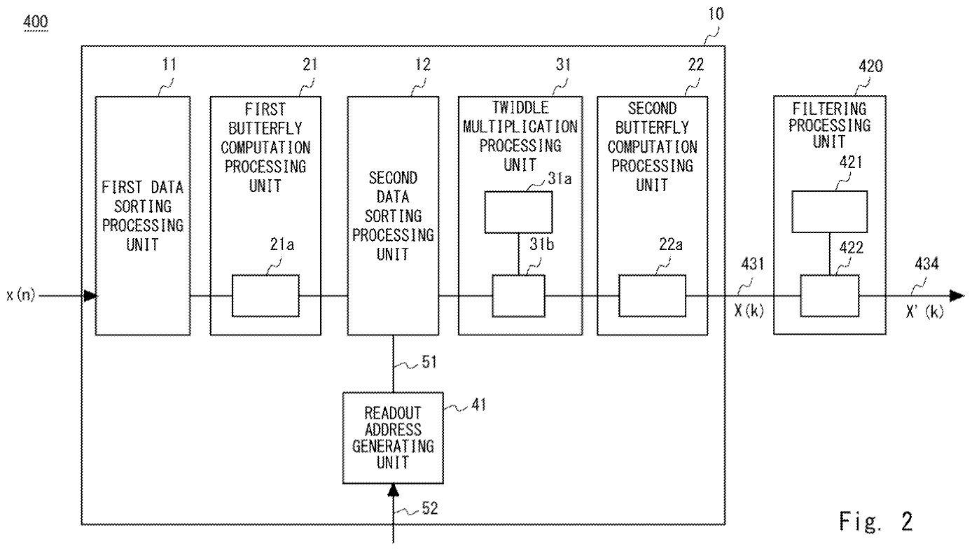

FIG. 2 is a block diagram illustrating a configuration of a digital filtering device (also referred to as a digital filtering circuit) 400 according to a second example embodiment of the present disclosure. The digital filtering circuit 400 includes an FFT device (also referred to as an FFT circuit) 10 and a filtering processing unit 420 serving as a filtering processing means.

The digital filtering circuit 400 receives an input of a complex signal in the time domain.

x(n)=r(n)+js(n) (1)

The FFT circuit 10 transforms the input complex signal x(n) into a complex signal 431 in the frequency domain through FFT.

X(k)=A(k)+jB(k) (2)

In the above, n is an integer that satisfies 0≤n≤N−1, indicating a signal sample number in the time domain; N is an integer that satisfies 0<N, indicating the number of transform samples of FFT; and k is an integer that satisfies 0≤k≤N−1, indicating a frequency number in the frequency domain.

Next, the filtering processing unit 420 performs, on X(k) (Equation (2)) that the FFT circuit 10 outputs to the complex signal 431, a complex filtering process through complex multiplication with use of a filter coefficient C(k). Specifically, for each frequency number k, where k satisfies 0≤k≤N−1, the filtering processing unit 420 calculates a complex signal below and outputs the calculated complex signal as a complex signal 434.

X′(k)=X(k)×C(k) (3)

The digital filtering circuit 400 performs the process described above repetitively on the consecutively input time-domain complex signals in units of N complex signals.

Now, details of the FFT circuit 10 according to the second example embodiment of the present disclosure will be described.

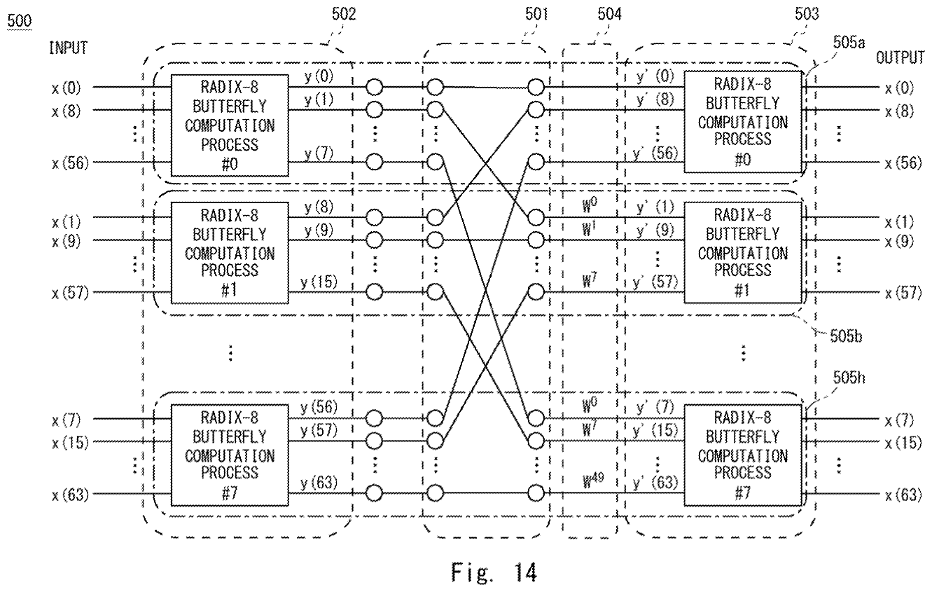

The FFT device 10 processes, through a pipelined circuit system, a 64-point FFT that has been broken down into a two-stage radix-8 butterfly process, in accordance with the data flow 500 shown in FIG. 14. The FFT device 10 receives an input of time-domain data x(n) (n=0, 1, . . . , N−1), generates a frequency-domain signal X(k) (k=0, 1, . . . , N−1) by Fourier-transforming x(n) through an FFT process, and outputs the generated frequency-domain signal X(k). In the above, N is a positive integer representing an FFT block size.

The FFT device 10 includes a first data sorting processing unit 11 serving as a first data sorting processing means, a first butterfly computation processing unit 21 serving as a butterfly computation processing means, a second data sorting processing unit 12 serving as a second data sorting processing means as well as a storage means, a twiddle multiplication processing unit 31 serving as a twiddle multiplication processing means, a second butterfly computation processing unit 22, and a readout address generating unit 41 serving as a readout address generating means. The FFT device 10 performs, in a pipeline process, a first data sorting process, a first butterfly computation process, a second data sorting process, a twiddle multiplication process, and a second butterfly computation process.

The first data sorting processing unit 11 and the second data sorting processing unit 12 serve as a buffer circuit for data sorting. Before the first butterfly computation processing unit 21, the first data sorting processing unit 11 sorts the data sequence based on the dependence relationship of data in the FFT processing algorithm. In a similar manner, after the first butterfly computation processing unit 21, the second data sorting processing unit 12 receives an input of a readout address 51 and sorts the data sequence based on the dependence relationship of data in the FFT processing algorithm. Furthermore, the second data sorting processing unit 12 performs, in addition to the stated sorting, a sorting process for executing the consecutively executed FFT processes in an alternating manner.

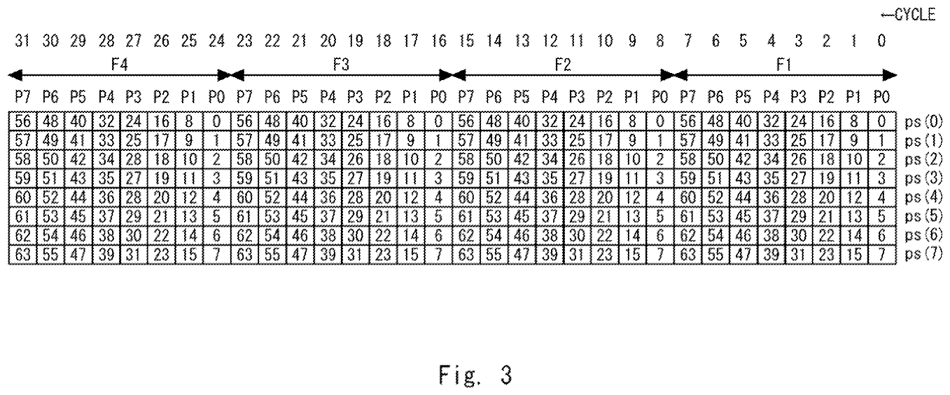

The FFT device 10 performs a 64-point FFT process with eight data items in parallel. In this case, the FFT circuit 10 receives an input of time-domain data x(n), generates a frequency-domain signal X(k) Fourier-transformed through an FFT process, and outputs the generated frequency-domain signal X(k). At this point, as input data x(n), a total of 64 data items are input in a single FFT process in the order shown in FIG. 3 over eight cycles with each cycle containing eight data items. FIG. 3 shows the order of input data x(n) in first to fourth FFT processes (F1 to F4) performed consecutively, and the numerals 0 to 63 in the table shown in FIG. 3 represent the index n in x(n). Specifically, in the first FFT process (F1), the eight data items x(0), x(1), . . . , x(7) constituting a data set P0 are input in the 0th cycle. Then, the eight data items x(8), x(9), . . . , x(15) constituting a data set P1 are input in the 1st cycle. Thereafter, in a similar manner, data constituting data sets P2 to P7 are input in the 2nd to 7th cycles, respectively. In a similar manner, data for the second FFT process (F2) are input in the 8th to 15th cycles, data for the third FFT process (F3) are input in the 16th to 23rd cycles, and data for the fourth FFT process (F4) are input in the 24th to 31st cycles.

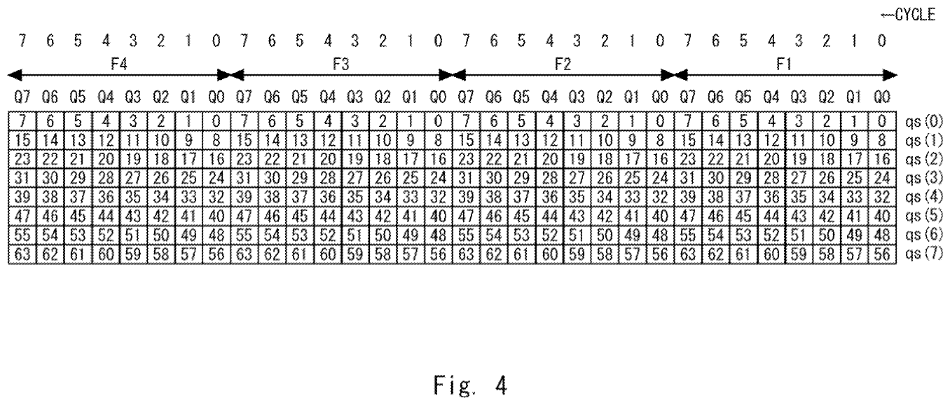

Next, the first data sorting processing unit 11 changes the sequential order shown in FIG. 3, in which the input data x(n) have been input, to a bit-reverse order shown in FIG. 4, in which the data are to be input to the first butterfly computation processing unit 21.

FIG. 4 shows a bit-reverse order for the first to fourth FFT processes (F1 to F4) performed consecutively and corresponds to a data set input to the first-stage radix-8 butterfly process 502 in the data flow shown in FIG. 14. Specifically, for the first FFT process (F1), the first data sorting processing unit 11 outputs the eight data items x(0), x(8), . . . , x(56) constituting a data set Q0 in the 0th cycle. Then, the first data sorting processing unit 11 outputs the eight data items x(1), x(9), . . . , x(57) constituting a data set Q1 in the 1st cycle. Thereafter, in a similar manner, the first data sorting processing unit 11 outputs data constituting data sets Q2 to Q7 in the 2nd to 7th cycles, respectively. In a similar manner, the first data sorting processing unit 11 outputs data for the second FFT process (F2) in the 8th to 15th cycles, outputs data for the third FFT process (F3) in the 16th to 23rd cycles, and outputs data for the fourth FFT process (F4) in the 24th to 31st cycles.

Now, the sequential order and the bit-reverse order will be described specifically. The sequential order refers to the order of the eight data sets P0 to P7 shown in FIG. 3. Each data set Ps (s=0, 1, . . . , 7) consists of eight data items arrayed sequentially from ps(0) to ps(7), and ps(i) is expressed as follows.

ps(i)=8s+i

In other words, in the sequential order, (i×s) data are arrayed such that i data items from the head are arrayed in the order of the data to form a data set and s such data sets are arrayed.

The bit-reverse order refers to the order of the eight data sets Q0 to Q7 shown in FIG. 4. Each data set Qs (s=0, 1, . . . , 7) consists of eight data items qs(0) to qs(7), and qs(i) is expressed as follows.

qs(i)=s+8i

In other words, in the bit-reverse order, (i×s) data items are arrayed such that i data items from the head with one data item taken at every eight data items are arrayed to form a data set and s such data sets are arrayed.

As described above, the ith data of the data items constituting each data set Qs (s=0, 1, . . . , 7) in the bit-reverse order is the sth data constituting a data set Pi in the sequential order. In other words, the following holds.

Qs(i)=Pi(s)

In this manner, Qs(i) and Pi(s) are in a relationship in which, of the data constituting each data set, the order of the data sets and the order with respect to the data position within the data set are switched. Therefore, when the data input in the bit-reverse order are sorted in accordance with the bit-reverse order, this results in the sequential order.

Each row ps(i) in FIG. 3 and each row qs(i) in FIG. 4 each indicate the ith data input in the following stage. The eight numerals included in each data are each identification information that identifies one of the points in FFT and is specifically the value of the index n in x(n).

The sequential order and the bit-reverse order are not limited to those shown in FIGS. 3 and 4. In other words, as described above, each data set in the sequential order may be created by arraying data sequentially in accordance with the number of points in FFT, the number of cycles, and the number of data items to be processed in parallel. Meanwhile, as described above, each data set in the bit-reverse order may be created by changing the order of data input in the sequential order that follows the progress of the cycles to the order that follows the data position.

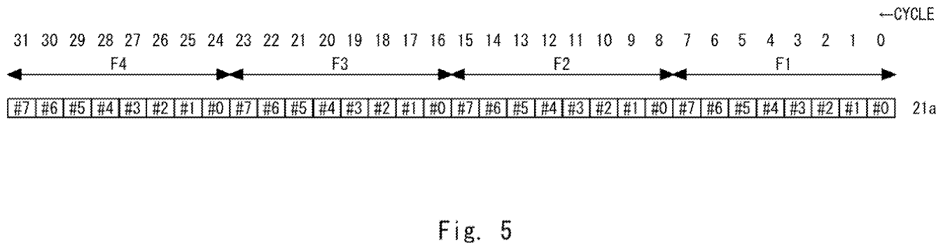

The first butterfly computation processing unit 21 is a butterfly circuit that performs the first butterfly computation process 502 (first butterfly computation process) of the two-stage radix-8 butterfly computation process in the data flow 500 shown in FIG. 14. The first butterfly computation processing unit 21 includes a radix-8 butterfly computation processing unit 21a and performs a radix-8 butterfly computation process. FIG. 5 shows the processing order of the first butterfly computation processing unit 21 in the first to fourth FFT processes (F1 to F4) performed consecutively. Specifically, the first butterfly computation processing unit 21 performs, in the order shown in FIG. 5, eight radix-8 butterfly computation processes #0 to #7 of the butterfly computation process 502 of the first FFT process (F1) in the 0th to 7th cycles, respectively.

In other words, in cycle 0, the radix-8 butterfly computation processing unit 21a receives an input of a data set Q0 of the bit-reverse order that corresponds to the radix-8 butterfly computation process #0 and that is output by the first data sorting processing unit 11, and performs the radix-8 butterfly computation process #0. In cycle 1, the radix-8 butterfly computation processing unit 21a receives an input of a data set Q1 of the bit-reverse order that corresponds to the radix-8 butterfly computation process #1 and that is output by the first data sorting processing unit 11, and performs the radix-8 butterfly computation process #1. In cycle 2, the radix-8 butterfly computation processing unit 21a receives an input of a data set Q2 of the bit-reverse order that corresponds to the radix-8 butterfly computation process #2 and that is output by the first data sorting processing unit 11, and performs the radix-8 butterfly computation process #2. In cycle 3, the radix-8 butterfly computation processing unit 21a receives an input of a data set Q3 of the bit-reverse order that corresponds to the radix-8 butterfly computation process #3 and that is output by the first data sorting processing unit 11, and performs the radix-8 butterfly computation process #3. In the cycles thereafter, in a similar manner, in cycles 4 to 7, the radix-8 butterfly computation processing unit 21a receives an input of, respectively, data sets Q4 to Q7 of the bit-reverse order that correspond to the respective radix-8 butterfly computation processes #4 to #7 and that are output by the first data sorting processing unit 11, and performs the respective radix-8 butterfly computation processes #4 to #7.

In a similar manner, the first butterfly computation processing unit 21 performs the process for the second FFT process (F2) in the 8th to 15th cycles, performs the process for the third FFT process (F3) in the 16th to 23rd cycles, and performs the process for the fourth FFT process (F4) in the 24th to 31st cycles.

The first butterfly computation processing unit 21 outputs the results of the butterfly computation processes in the form of data y(n) (n=0, 1, . . . , 63) in the sequential order shown in FIG. 3.

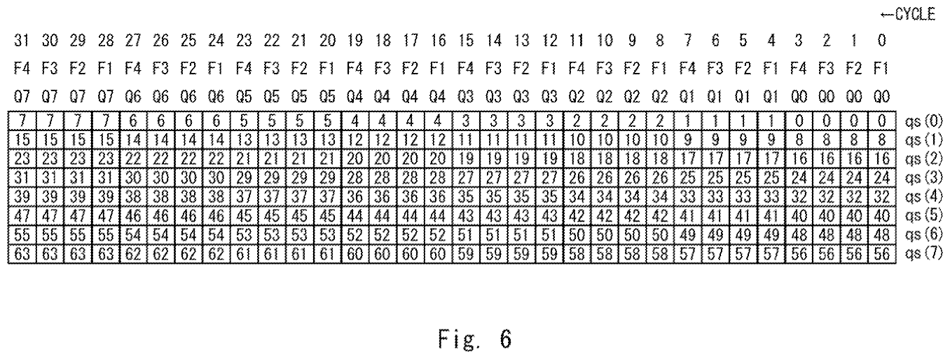

The second data sorting processing unit 12 sorts the data y(n) output in the sequential order by the first butterfly computation processing unit 21 into the order shown in FIG. 6 (referred to below as an FFT frame interleave bit-reverse order). The FFT frame interleave bit-reverse order concerns an order in which s data sets Qs for a single FFT process that have been created in the bit-reverse order are output as the cycles advance in a plurality of FFT processes performed consecutively, and can be specified by an output order specification 52. According to the present example embodiment, the FFT frame interleave bit-reverse order specifies an order in which Q0s of the first to fourth FFT processes are ordered consecutively, Q1s of the first to fourth FFT processes are then ordered consecutively, Q2s of the first to fourth FFT processes are then ordered consecutively, Q3s of the first to fourth FFT processes are then ordered consecutively, Q4s of the first to fourth FFT processes are then ordered consecutively, Q5s of the first to fourth FFT processes are then ordered consecutively, Q6s of the first to fourth FFT processes are then ordered consecutively, and Q7s of the first to fourth FFT processes are then ordered consecutively.

The second data sorting processing unit 12 receives an input of a readout address 51 that the readout address generating unit 41 outputs, and determines the output order. The readout address generating unit 41 generates the readout address 51 to be output to the second data sorting process unit 12, by referring to an output order setting 52 provided from a higher-order circuit (not illustrated), such as a central processing unit (CPU).

Specifically, the second data sorting processing unit 12 outputs Q0 of the first FFT process in the 0th cycle, outputs Q0 of the second FFT process in the 1st cycle, outputs Q0 of the third FFT process in the 2nd cycle, and outputs Q0 of the fourth FFT process in the 3rd cycle. In a similar manner, the second data sorting processing unit 12 outputs Q1 of the first FFT process in the 4th cycle, outputs Q1 of the second FFT process in the 5th cycle, outputs Q1 of the third FFT process in the 6th cycle, and outputs Q1 of the fourth FFT process in the 7th cycle. Thereafter, in a similar manner, the second data sorting processing unit 12 outputs Q2s of the first to fourth FFT processes in the 8th to 11th cycles, outputs Q3s of the first to fourth FFT processes in the 12th to 15th cycles, outputs Q4s of the first to fourth FFT processes in the 16th to 19th cycles, outputs Q5s of the first to fourth FFT processes in the 20th to 23rd cycles, outputs Q6s of the first to fourth FFT processes in the 24th to 27th cycles, and outputs Q7s of the first to fourth FFT processes in the 28th to 31st cycles.

In other words, the FFT frame interleave bit-reverse order can be regarded as an order in which the processing order of a plurality of FFT processes is interleaved such that the processes of the Cth cycle (C is an integer satisfying 0≤C≤7) in F FFT processes (F is a positive integer of 2 or higher) performed consecutively are performed in a consecutive cycle.

The twiddle multiplication processing unit 31 is a circuit that processes complex rotation in a complex plane in FFT computation after the first butterfly computation process, and corresponds to the twiddle multiplication process 504 in the data flow 500 shown in FIG. 14. Herein, data are not sorted in the twiddle multiplication process.

The twiddle multiplication processing unit 31 includes a twiddle coefficient table 31a and a twiddle multiplication unit 31b. The twiddle coefficient table 31a outputs a twiddle coefficient W(n) (n=0, 1, . . . , 63) corresponding to the data y(n) (n=0, 1, . . . , 63) in each FFT process that the second data sorting processing unit 12 outputs in the FFT frame interleave bit-reverse order. W(n) is a twiddle coefficient corresponding to the data y(n).

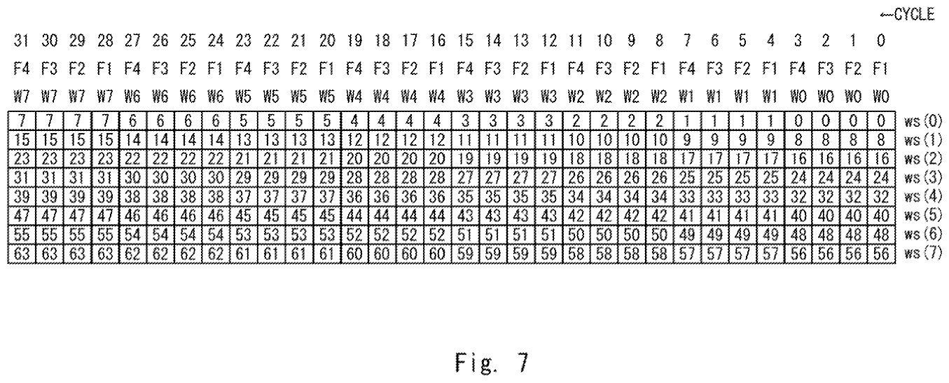

Therefore, the order in which the twiddle multiplication processing unit 31 outputs the twiddle coefficient W(n) is determined uniquely by the FFT frame interleave bit-reverse order, which is the order in which the second data sorting processing unit 12 outputs the sorted data. Specifically, if the second data sorting processing unit 12 outputs data in the FFT frame interleave bit-reverse order shown in FIG. 6, the twiddle coefficient table 31a outputs the twiddle coefficient in the order shown in FIG. 7. As is clear from FIGS. 6 and 7, the twiddle coefficient W(n) (n=0, 1, . . . , 63) that the twiddle multiplication processing unit 31 outputs corresponds to y(n) that the second data sorting processing unit 12 outputs.

The twiddle multiplication unit 31b performs a twiddle multiplication process by multiplying y(n) that the second data sorting processing unit 12 outputs and the twiddle coefficient W(n) that the twiddle multiplication processing unit 31 outputs, and outputs the result to the second butterfly computation processing unit 22.

The second butterfly computation processing unit 22 is a butterfly circuit that performs the second butterfly computation process 503 (second butterfly computation process) of the two-stage radix-8 butterfly computation process in the data flow 500 shown in FIG. 14. The second butterfly computation processing unit 22 includes a radix-8 butterfly computation processing unit 22a and performs a radix-8 butterfly computation process.

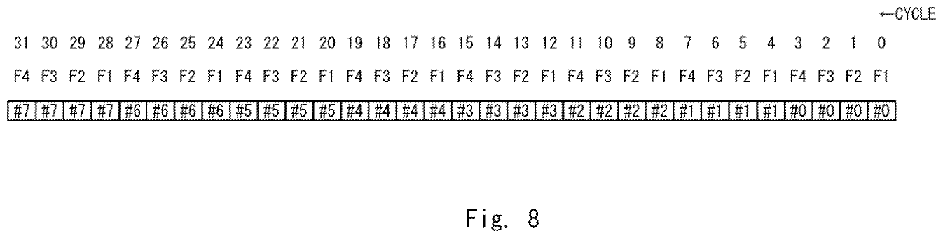

FIG. 8 shows the processing order of the second butterfly computation processing unit 22 in the first to fourth FFT processes (F1 to F4) performed consecutively. Specifically, the second butterfly computation processing unit 22 performs radix-8 butterfly computation processes of #0 constituting the butterfly computation process 503 in the 0th to 3rd cycles of the first to fourth FFT processes (F1 to F4). In a similar manner, the second butterfly computation processing unit 22, of the first to fourth FFT processes (F1 to F4), performs radix-8 butterfly computation processes of #1 constituting the butterfly computation process 503 in the 4th to 7th cycles, performs radix-8 butterfly computation processes of #2 constituting the butterfly computation process 503 in the 8th to 11th cycles, performs radix-8 butterfly computation processes of #3 constituting the butterfly computation process 503 in the 12th to 15th cycles, performs radix-8 butterfly computation processes of #4 constituting the butterfly computation process 503 in the 16th to 19th cycles, performs radix-8 butterfly computation processes of #5 constituting the butterfly computation process 503 in the 20th to 23rd cycles, performs radix-8 butterfly computation processes of #6 constituting the butterfly computation process 503 in the 24th to 27th cycles, and performs radix-8 butterfly computation processes of #7 constituting the butterfly computation process 503 in the 28th to 31st cycles.

In other words, in cycle 0, for the first FFT process (F1), the radix-8 butterfly computation processing unit 22a receives an input of a data set Q0 of the bit-reverse order that corresponds to the radix-8 butterfly computation process #0 and that is output by the second data sorting processing unit 12, and performs the radix-8 butterfly computation process #0. In cycle 1, for the second FFT process (F2), the radix-8 butterfly computation processing unit 22a receives an input of a data set Q0 of the bit-reverse order that corresponds to the radix-8 butterfly computation process #0 and that is output by the second data sorting processing unit 12, and performs the radix-8 butterfly computation process #0. In cycle 2, for the third FFT process (F3), the radix-8 butterfly computation processing unit 22a receives an input of a data set Q0 of the bit-reverse order that corresponds to the radix-8 butterfly computation process #0 and that is output by the second data sorting processing unit 12, and performs the radix-8 butterfly computation process #0. In cycle 3, for the fourth FFT process (F4), the radix-8 butterfly computation processing unit 22a receives an input of a data set Q0 of the bit-reverse order that corresponds to the radix-8 butterfly computation process #0 and that is output by the second data sorting processing unit 12, and performs the radix-8 butterfly computation process #0.

In the cycles thereafter, in a similar manner, the radix-8 butterfly computation processing unit 22a performs processes as follows.

In cycles 4 to 7, for the first to fourth FFT processes (F1 to F4), the radix-8 butterfly computation processing unit 22a receives an input of data sets Q1 of the bit-reverse order that correspond to the radix-8 butterfly computation processes #1 and that are output by the second data sorting processing unit 12, and performs the radix-8 butterfly computation processes #1.

In cycles 8 to 11, for the first to fourth FFT processes (F1 to F4), the radix-8 butterfly computation processing unit 22a receives an input of data sets Q2 of the bit-reverse order that correspond to the radix-8 butterfly computation processes #2 and that are output by the second data sorting processing unit 12, and performs the radix-8 butterfly computation processes #2.

In cycles 12 to 15, for the first to fourth FFT processes (F1 to F4), the radix-8 butterfly computation processing unit 22a receives an input of data sets Q3 of the bit-reverse order that correspond to the radix-8 butterfly computation processes #3 and that are output by the second data sorting processing unit 12, and performs the radix-8 butterfly computation processes #3.

In cycles 16 to 19, for the first to fourth FFT processes (F1 to F4), the radix-8 butterfly computation processing unit 22a receives an input of data sets Q4 of the bit-reverse order that correspond to the radix-8 butterfly computation processes #4 and that are output by the second data sorting processing unit 12, and performs the radix-8 butterfly computation processes #4.

In cycles 20 to 23, for the first to fourth FFT processes (F1 to F4), the radix-8 butterfly computation processing unit 22a receives an input of data sets Q5 of the bit-reverse order that correspond to the radix-8 butterfly computation processes #5 and that are output by the second data sorting processing unit 12, and performs the radix-8 butterfly computation processes #5.

In cycles 24 to 27, for the first to fourth FFT processes (F1 to F4), the radix-8 butterfly computation processing unit 22a receives an input of data sets Q6 of the bit-reverse order that correspond to the radix-8 butterfly computation processes #6 and that are output by the second data sorting processing unit 12, and performs the radix-8 butterfly computation processes #6.

In cycles 28 to 31, for the first to fourth FFT processes (F1 to F4), the radix-8 butterfly computation processing unit 22a receives an input of data sets Q7 of the bit-reverse order that correspond to the radix-8 butterfly computation processes #7 and that are output by the second data sorting processing unit 12, and performs the radix-8 butterfly computation processes #7.

For the first to fourth FFT processes (F1 to F4), the second butterfly computation processing unit 22 outputs the results X(k) (n=0, 1, . . . , 63) of the butterfly computation processes also in the FFT frame interleave bit-reverse order.

The first data sorting processing unit 11 and the second data sorting processing unit 12 tentatively store input data, and by controlling the selection and output of the stored data, implement the process of sorting the data in accordance with the bit-reverse order shown in FIG. 4 or the FFT frame interleave bit-reverse order shown in FIG. 6. Specific examples of data sorting processing units will be described below.

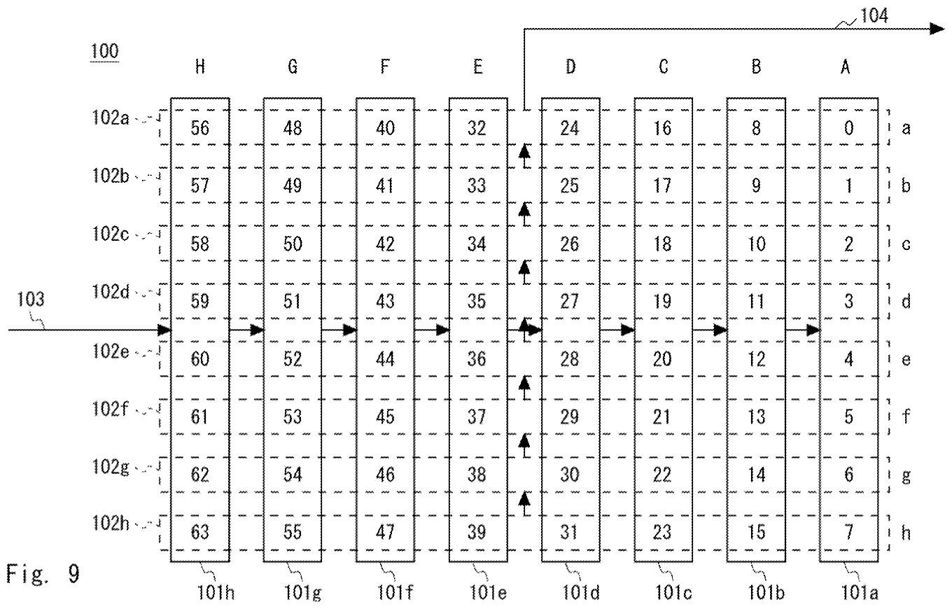

The first data sorting processing unit 11 can be implemented, for example, by a data sorting processing unit 100 shown in FIG. 9.

The data sorting processing unit 100 receives, as input information 103, an input of data sets A to H each consisting of eight data items that are input in the first-in order in a first-in first-out (FIFO) buffer, and writes and stores these data sets A to H at data storage locations 101a to 101h, respectively. Specifically, the data sets A to H are stored in the respective data storage locations 101a to 101h.

Next, the data sorting processing unit 100 outputs the stored data two data sets by two data sets in the first-out order in the FIFO buffer. Specifically, the data sorting processing unit 100 reads out eight data items from respective data readout positions 102a to 102h to create one data set and outputs eight data sets a to h as output information 104. In this manner, the data sets a to h are each a set obtained by sorting the data included in the data sets A to H arrayed in the order of the cycles into the order of the data positions.

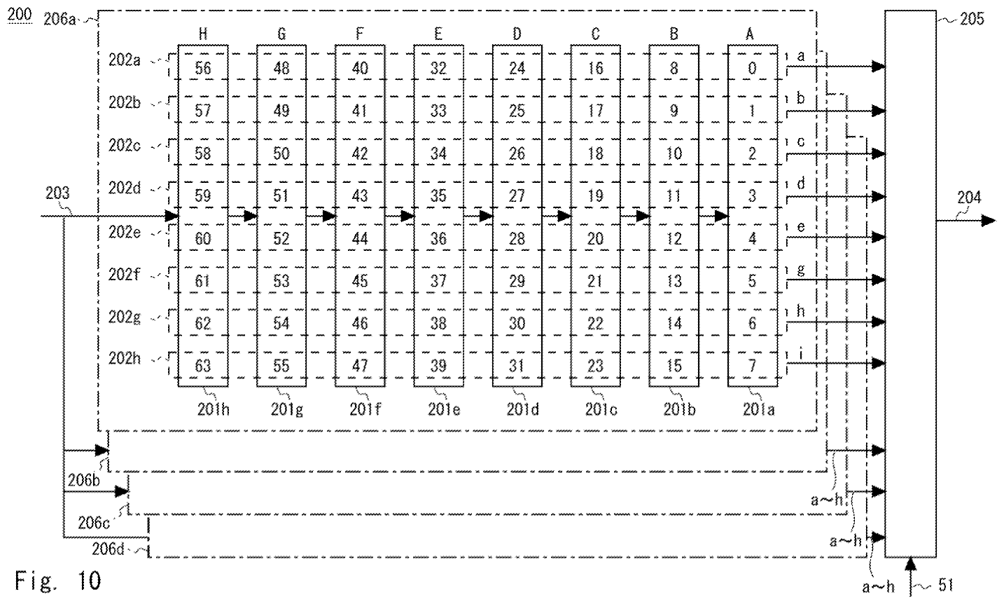

FIG. 10 is a configuration diagram of a data sorting processing unit 200 serving as an implementation example of the second data sorting processing unit 12. The data sorting processing unit 200 includes four partial data sorting processing units 206a, 206b, 206c, and 206d corresponding to the first to fourth FFT processes (F1 to F4), respectively.

First, in the first FFT process (F1), the partial data sorting processing unit 206a receives, as input data 203, data sets A to H each consisting of eight data items that are input in the first-in order in a FIFO buffer, and writes and stores these data sets A to H into data storage locations 201a to 201h, respectively. Specifically, the data sets A to H are stored sequentially into the respective data storage locations 201a to 201h in the order of the cycles. At this point, when the stored data are seen in the order of the data positions, that is, in the order of the data storage locations 201a to 201h, the data storage locations 201a to 201h have respective data sets a to h stored therein.

In a similar manner, in the second FFT process (F2), the partial data sorting processing unit 206b receives, as input data 203, data sets A to H each consisting of eight data items that are input in the first-in order in the FIFO buffer, and writes and stores these data sets A to H into the data storage locations 201a to 201h. In the third FFT process (F3), the partial data sorting processing unit 206c receives, as input data 203, data sets A to H each consisting of eight data items that are input in the first-in order in the FIFO buffer, and writes and stores these data sets A to H into the data storage locations 201a to 201h. In the fourth FFT process (F4), the partial data sorting processing unit 206d receives, as input data 203, data sets A to H each consisting of eight data items that are input in the first-in order in the FIFO buffer, and writes and stores these data sets A to H into the data storage locations 201a to 201h.

Next, the data sorting processing unit 200 reads out the stored data one data set by one data set via a readout circuit 205 and outputs the read-out data as output data 204. At this point, the readout circuit 205 selects any one from the partial data sorting processing units 206a to 206d by referring to a readout address 51, further selects any one from the data storage locations 201a to 201h of the selected partial data sorting processing unit, and reads out any one of the eight data items stored in the selected data storage location of the data storage locations 201a to 201h in a single readout operation. In this manner, by assigning readout addresses of a desired combination and order that can be specified as desired in the readout address 51, data can be read out in any combination and in any order. For example, if readout addresses are given to the readout address 51 in the order of: address 0 of the partial data sorting processing unit 206a, address 0 of the partial data sorting processing unit 206b, address 0 of the partial data sorting processing unit 206c, and address 0 of the partial data sorting processing unit 206d; address 1 of the partial data sorting processing unit 206a, address 1 of the partial data sorting processing unit 206b, address 1 of the partial data sorting processing unit 206c, and address 1 of the partial data sorting processing unit 206d; address 2 of the partial data sorting processing unit 206a, address 2 of the partial data sorting processing unit 206b, address 2 of the partial data sorting processing unit 206c, and address 2 of the partial data sorting processing unit 206d; address 3 of the partial data sorting processing unit 206a, address 3 of the partial data sorting processing unit 206b, address 3 of the partial data sorting processing unit 206c, and address 3 of the partial data sorting processing unit 206d; address 4 of the partial data sorting processing unit 206a, address 4 of the partial data sorting processing unit 206b, address 4 of the partial data sorting processing unit 206c, and address 4 of the partial data sorting processing unit 206d; address 5 of the partial data sorting processing unit 206a, address 5 of the partial data sorting processing unit 206b, address 5 of the partial data sorting processing unit 206c, and address 5 of the partial data sorting processing unit 206d; address 6 of the partial data sorting processing unit 206a, address 6 of the partial data sorting processing unit 206b, address 6 of the partial data sorting processing unit 206c, and address 6 of the partial data sorting processing unit 206d; and address 7 of the partial data sorting processing unit 206a, address 7 of the partial data sorting processing unit 206b, address 7 of the partial data sorting processing unit 206c, and address 7 of the partial data sorting processing unit 206d, the data sorting processing unit 200 outputs the stored data in the order of a data set a of the first FFT process (F1), a data set a of the second FFT process (F2), a data set a of the third FFT process (F3), and a data set a of the fourth FFT process (F4). Thereafter, in a similar manner, the data sorting processing unit 200 outputs the stored data in the order of: four data sets b corresponding to the first to fourth FFT processes (F1 to F4), respectively; four data sets c corresponding to the first to fourth FFT processes (F1 to F4), respectively; four data sets d corresponding to the first to fourth FFT processes (F1 to F4), respectively; four data sets e corresponding to the first to fourth FFT processes (F1 to F4), respectively; four data sets f corresponding to the first to fourth FFT processes (F1 to F4), respectively; four data sets g corresponding to the first to fourth FFT processes (F1 to F4), respectively; and four data sets h corresponding to the first to fourth FFT processes (F1 to F4), respectively. In other words, the data are output in the FFT frame interleave bit-reverse order shown in FIG. 6. Herein, the data sets a to h are each a set obtained by sorting data included in the data sets A to H arrayed in the order of the cycles into the order of the data positions.

As described above, in the FFT device 10, the process of sorting data are performed twice in accordance with the sequential order shown in FIG. 3, the bit-reverse order shown in FIG. 4, and the FFT frame interleave bit-reverse order shown in FIG. 6 by the first data sorting processing unit 11 and the second data sorting processing unit 12.

Next, details of the filtering processing unit 420 according to the second example embodiment of the present disclosure will be described.

The filtering processing unit 420 is a circuit that performs a complex filtering process through complex multiplication after the process of the FFT circuit 10. The filtering processing unit 420 includes a filter coefficient table 421 and a filtering multiplication unit 422. The filter coefficient table 421 outputs a filter coefficient C(k) (k=0, 1, . . . , 63) in accordance with the data X(k) (k=0, 1, . . . , 63) that the FFT circuit 10 outputs to the complex signal 431 in the FFT frame interleave bit-reverse order. C(k) is a filter coefficient corresponding to the data X(k). Therefore, the order in which the filter coefficient table 421 outputs the filter coefficient C(k) is determined uniquely by the FFT frame interleave bit-reverse order, which is the order in which the FFT circuit 10 outputs X(k).

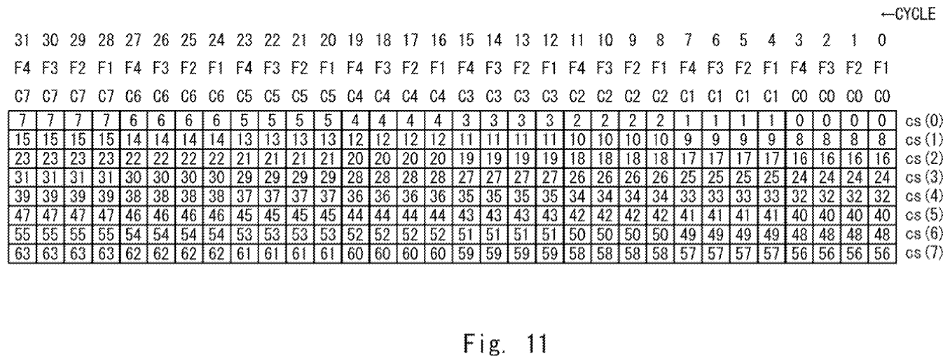

Specifically, when the FFT circuit 10 outputs X(k) in the FFT frame interleave bit-reverse order shown in FIG. 6, the filter coefficient table 421 outputs the filter coefficient in the order shown in FIG. 11. As is clear from FIGS. 6 and 11, the filter coefficient C(k) (k=0, 1, . . . , 63) corresponds to the data X(k) that the FFT circuit 10 outputs.

The filtering multiplication unit 422 performs a filtering multiplication process by multiplying the data X(k) that the FFT circuit 10 outputs and the filter coefficient C(k) that the filter coefficient table 421 outputs, and outputs the resultant to the complex signal 434.

Now, a difference will be described between the FFT frame interleave bit-reverse order, which is the data order that the present example embodiment employs after the output of the second data sorting processing unit 12, and the bit-reverse order that the present example embodiment employs before the input of the second data sorting processing unit 12.

According to the present example embodiment, the order in which the twiddle multiplication processing unit 31 outputs the twiddle coefficient W(n) is determined by the FFT frame interleave bit-reverse order, which is the order in which the second data sorting processing unit 12 outputs data. Specifically, the twiddle multiplication processing unit 31 outputs the twiddle coefficient W(m) in the order shown in FIG. 7.

As is clear from FIG. 7, the values of ws(0) to ws(7) in the twiddle coefficient W(n) are identical in cycles 0 to 3, are identical in cycles 4 to 7, and, in the cycles thereafter as well, are identical in each set of four cycles corresponding to the first to fourth FFT processes (F1 to F4).

A closer look at the power consumption of the twiddle multiplication processing unit 31 shows that the magnitude of the change in the values of the eight data items ws(0) to ws(7) greatly influences the power consumption.

Specifically, in binary values expressing the twiddle coefficient W(n) in a binary number, the operation rate per bit (toggle rate) of the eight data items ws(0) to ws(7) greatly influences the power consumption. This is because the dynamic power consumption (dynamic power) P of the digital signal processing circuit implemented by a complementary metal-oxide semiconductor (CMOS) circuit can be expressed through Equation (4) below,

P=(½)*a*C*V2*f (4)

in the above,
a: circuit operation rate,
C: load capacitance,
V: voltage,
f: operation frequency, and
   because the operation rate per bit of the eight data items ws(0) to ws(7) greatly influences the circuit operation rate a. In other words, selecting the output order that can reduce the operation rate per bit of the eight data items ws(0) to ws(7) is effective in reducing the power consumption of the twiddle multiplication processing unit 31.

The FFT frame interleave bit-reverse order according to the present example embodiment can reduce the operation rate related to the twiddle coefficient W(n), as compared with, for example, the bit-reverse order, since the value of the twiddle coefficient W(n) does not change within four cycles corresponding to the first to fourth FFT processes (F1 to F4). As a result, the FFT frame interleave bit-reverse order according to the present example embodiment can be regarded as an order that can reduce the power consumption related to the twiddle multiplication processing unit 31.

In a similar manner, the order in which the filtering processing unit 420 according to the present example embodiment outputs the filter coefficient C(k) is determined by the FFT frame interleave bit-reverse order, which is the order in which the second data sorting processing unit 12 outputs data. Specifically, the filtering processing unit 420 outputs the filter coefficient C(k) in the order shown in FIG. 11.

As is clear from FIG. 11, the values of cs(0) to cs(7) in the filter coefficient C(k) are identical in cycles 0 to 3, are identical in cycles 4 to 7, and, in the cycles thereafter as well, are identical in each set of four cycles corresponding to the first to fourth FFT processes (F1 to F4).

The FFT frame interleave bit-reverse order according to the present example embodiment can reduce the operation rate related to the filter coefficient C(k), as compared with, for example, the bit-reverse order, since the value of the filter coefficient C(k) does not change within four cycles corresponding to the first to fourth FFT processes (F1 to F4). As a result, the FFT frame interleave bit-reverse order according to the present example embodiment can be regarded as an order that can reduce the power consumption related to the filtering processing unit 420.

As described above, according to the present example embodiment, the FFT device 10 can output data in a desired order by specifying an order with use of the output order setting 52. For example, in a plurality of FFT processes performed consecutively, the power related to a twiddle computation process or a filter computation process can be reduced through an interleaved processing order. As a result, the power consumption in the overall digital filtering process can be reduced.

In the case described according to the present example embodiment, a 64-point FFT process (N=64) is performed in eight cycles (M=N/P=8) with eight data items processed in parallel (P=8). The number of points in an FFT process, however, is not limited to 64. The present example embodiment may be applied in a similar manner with any integer N of 2 or higher. Moreover, the number of data items processed in parallel is not limited to eight, and the process may be performed with P data items in parallel, where P is any integer of N or lower. In this case, a single N-point FFT process is performed in C=N/P cycles.

In the case described as an example according to the present example embodiment, the processing order of the four FFT processes performed consecutively is interleaved. The number of the FFT processes to be interleaved, however, is not limited to four. The processing order of F FFT processes performed consecutively may be interleaved, where F is any integer of 2 or higher. In this case, the operation rate related to the twiddle coefficient W(n) or the filter coefficient C(k) can be reduced to 1/F, and the power related to the twiddle computation process or the filter computation process can be reduced accordingly.

While an FFT process is described as an example according to the present example embodiment, the description applies in a similar manner in IFFT as well. Specifically, if the processing order within an IFFT process or in a stage that follows an IFFT process is optimized by applying the control method according to the present example embodiment to an IFFT processing device, the power consumption in the IFFT process or in the stage that follows the IFFT process can be reduced.

### Third Example Embodiment

A digital filtering circuit according to a third example embodiment of the present disclosure has a circuit configuration identical to that of the digital filtering circuit 400 according to the second example embodiment, but an order different from that according to the second example embodiment is specified in an output order specification 52.

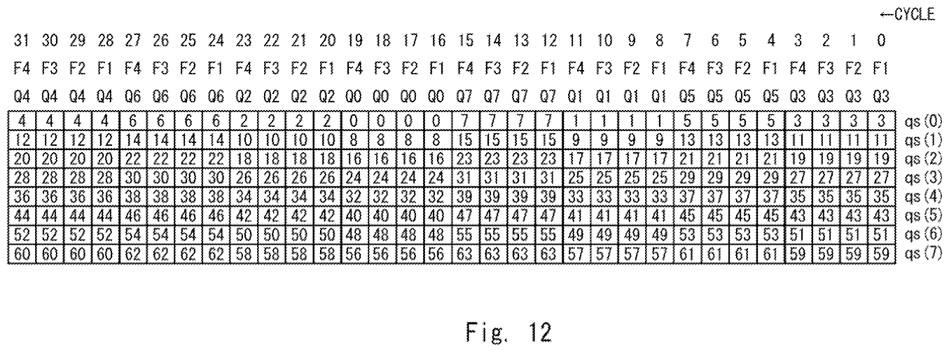

A second data sorting processing unit 12 according to the third example embodiment sorts data y(n) output in the sequential order by a first butterfly computation processing unit 21 into the order shown in FIG. 12 (referred to below as an FFT frame interleave power optimization bit-reverse order). The FFT frame interleave power optimization bit-reverse order concerns an order in which s data sets Qs for a single FFT process that have been created in the bit-reverse order are output as the cycles advance in a plurality of FFT processes performed consecutively, and can be specified by the output order specification 52. According to the present example embodiment, the FFT frame interleave power optimization bit-reverse order specifies an order in which Q3s of the first to fourth FFT processes are ordered consecutively, Q5s of the first to fourth FFT processes are then ordered consecutively, Q1s of the first to fourth FFT processes are then ordered consecutively, Q7s of the first to fourth FFT processes are then ordered consecutively, Q0s of the first to fourth FFT processes are then ordered consecutively, Q2s of the first to fourth FFT processes are then ordered consecutively, Q6s of the first to fourth FFT processes are then ordered consecutively, and Q4s of the first to fourth FFT processes are then ordered consecutively.

The second data sorting processing unit 12 receives an input of a readout address 51 that a readout address generating unit 41 outputs, and determines the output order. The readout address generating unit 41 generates the readout address 51 to be output to the second data sorting process unit 12, by referring to the output order setting 52 provided from a higher-order circuit (not illustrated), such as a central processing unit (CPU).

Specifically, the second data sorting processing unit 12 outputs Q3 of the first FFT process in the 0th cycle, outputs Q3 of the second FFT process in the 1st cycle, outputs Q3 of the third FFT process in the 2nd cycle, and outputs Q3 of the fourth FFT process in the 3rd cycle. In a similar manner, the second data sorting processing unit 12 outputs Q5 of the first FFT process in the 4th cycle, outputs Q5 of the second FFT process in the 5th cycle, outputs Q5 of the third FFT process in the 6th cycle, and outputs Q5 of the fourth FFT process in the 7th cycle. Thereafter, in a similar manner, the second data sorting processing unit 12 outputs Q1s of the first to fourth FFT processes sequentially in the 8th to 11th cycles, outputs Q7s of the first to fourth FFT processes sequentially in the 12th to 15th cycles, outputs Q0s of the first to fourth FFT processes sequentially in the 16th to 19th cycles, outputs Q2s of the first to fourth FFT processes sequentially in the 20th to 23rd cycles, outputs Q6s of the first to fourth FFT processes sequentially in the 24th to 27th cycles, and outputs Q4s of the first to fourth FFT processes sequentially in the 28th to 31st cycles.

In other words, as with the FFT frame interleave bit-reverse order according to the second example embodiment, the FFT frame interleave power optimization bit-reverse order can be regarded as an order in which the processing order of a plurality of FFT processes is interleaved such that the processes of the Cth cycle (C is an integer satisfying 0≤C≤7) in F FFT processes (F is a positive integer of 2 or higher) performed consecutively are performed in a consecutive cycle.

A twiddle multiplication processing unit 31 according to the third example embodiment is a circuit that processes complex rotation in a complex plane in FFT computation after the first butterfly computation process, and corresponds to the twiddle multiplication process 504 in the data flow 500 shown in FIG. 14. Herein, data are not sorted in the twiddle multiplication process.

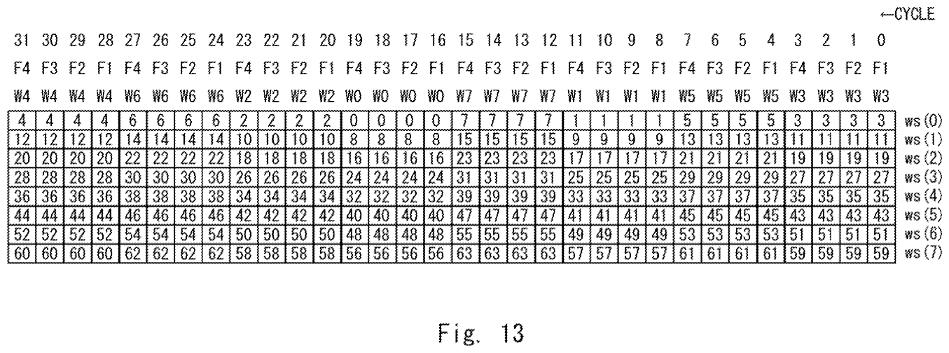

The twiddle multiplication processing unit 31 includes a twiddle coefficient table 31a and a twiddle multiplication unit 31b. The twiddle coefficient table 31a outputs a twiddle coefficient W(n) (n=0, 1, . . . , 63) corresponding to data y(n) (n=0, 1, . . . , 63) in each FFT process that the second data sorting processing unit 12 outputs in the FFT frame interleave power optimization bit-reverse order. W(n) is a twiddle coefficient corresponding to the data y(n). Therefore, the order in which the twiddle multiplication processing unit 31 outputs the twiddle coefficient W(n) is determined uniquely by the FFT frame interleave power optimization bit-reverse order, which is the order in which the second data sorting processing unit 12 outputs the sorted data. Specifically, when the second data sorting processing unit 12 outputs data in the FFT frame interleave power optimization bit-reverse order shown in FIG. 12, the twiddle coefficient table 31a outputs the twiddle coefficient in the order shown in FIG. 13. As is clear from FIGS. 12 and 13, the twiddle coefficient W(n) (n=0, 1, . . . , 63) that the twiddle multiplication processing unit 31 outputs corresponds to y(n) that the second data sorting processing unit 12 outputs.

Now, a difference will be described between the FFT frame interleave bit-reverse order, which is the data order that the second example embodiment employs after the output of the second data sorting processing unit 12, and the FFT frame interleave power optimization bit-reverse order, which is the data order that the present example embodiment employs after the output of the second data sorting processing unit 12.

According to the present example embodiment, as with the second example embodiment, the order in which the FFT device 10 outputs data is determined by the order in which the second data sorting processing unit 12 outputs data. In accordance therewith, the order in which the twiddle multiplication processing unit 31 according to the present example embodiment outputs the twiddle coefficient W(n) is determined by the order in which the second data sorting processing unit 12 outputs data.

In the FFT frame interleave bit-reverse order shown in FIG. 6 and in the FFT frame interleave power optimization bit-reverse order shown in FIG. 12, the data sets Qs are identical from cycle 0 to cycle 3, are identical from cycle 4 to cycle 7, and, in the cycles thereafter as well, are identical in each set of four cycles corresponding to the first to fourth FFT processes (F1 to F4). Meanwhile, the data set Qs changes from cycle 3 to cycle 4, changes from cycle 7 to cycle 8, changes from cycle 11 to cycle 12, changes from cycle 15 to cycle 16, changes from cycle 19 to cycle 20, changes from cycle 23 to cycle 24, and changes from cycle 27 to cycle 28, but the order in which the data set Qs changes differs in the FFT frame interleave bit-reverse order than in the FFT frame interleave power optimization bit-reverse order.

Specifically, whereas the data set Qs changes in the order of Q0, Q1, Q2, Q3, Q4, Q5, Q6, and Q7 in the FFT frame interleave bit-reverse order, the data set Qs changes in the order of Q3, Q5, Q1, Q7, Q0, Q2, Q6, and Q4 in the FFT frame interleave power optimization bit-reverse order. Therefore, as shown in FIG. 13, the twiddle coefficient W(n) also changes in the FFT frame interleave power optimization bit-reverse order.

The value of the twiddle coefficient W(n) is a value unique to an FFT process and is independent of the value of data input to the FFT device 10. In FIG. 13, the data sets W0 to W7 each consist of eight data items ws(0) to ws(7), and the values of ws(0) to ws(7) change in the order of W3, W5, W1, W7, W0, W2, W6, and W4, which is the FFT frame interleave bit-reverse order, in cycles 0 to 7.

A closer look at the power consumption of the twiddle multiplication processing unit 31 shows that the magnitude of the change in the values of the eight data items ws(0) to ws(7) greatly influences the power consumption. Specifically, in binary values expressing the twiddle coefficient W(n) in a binary number, the operation rate per bit (toggle rate) of the eight data items ws(0) to ws(7) greatly influences the power consumption. This is because the dynamic power consumption (dynamic power) P of the digital signal processing circuit implemented by a complementary metal-oxide semiconductor (CMOS) circuit can be expressed through Equation (4) below,

P=(½)*a*C*V2*f (4)

in the above,
a: circuit operation rate,
C: load capacitance,
V: voltage,
f: operation frequency, and
   because the operation rate per bit of the eight data items ws(0) to ws(7) greatly influences the circuit operation rate a. In other words, selecting the output order that can reduce the operation rate per bit of the eight data items ws(0) to ws(7) is effective in reducing the power consumption of the twiddle multiplication processing unit 31.

Specific methods of selecting an output order that can reduce the operation rate per bit of the eight data items ws(0) to ws(7) include a method in which a hamming distance is used as an index. A hamming distance is a distance between two data items, and in the case of binary data, the hamming distance is equal to the number of bits that differ between two binary data items. In other words, the operation rate held when certain twiddle coefficient data have changed is equal to the hamming distance between the coefficient data value held before the change and the coefficient data value held after the change. Therefore, the operation rate related to the twiddle coefficient W(n) can be calculated from the sum total of the hamming distances related to the twiddle coefficient W(n) in FFT processes.

For example, when the hamming distance between twiddle coefficients W(i) and W(j) is expressed as Hamming(i,j) and the hamming distance related to data ws(i) is expressed as H(i), since data ws(0) is W(3) in cycle 0, is W(5) in cycle 1, is W(1) in cycle 2, is W(7) in cycle 3, is W(0) in cycle 4, is W(2) in cycle 5, is W(6) in cycle 6, and is W(4) in cycle 7, the operation rate related to the twiddle coefficient W(n) in the FFT frame interleave bit-reverse order shown in FIG. 13 can be calculated through the following.

H(0)=Hamming(3,5)+Hamming(5,1)+Hamming(1,7)+Hamming(7,0)+Hamming(0,2)+Hamming(2,6)+Hamming(6,4)

In a similar manner, H(1) to H(7) can be calculated through the following.

H(1)=Hamming(11,13)+Hamming(13,9)+Hamming(9,15)+Hamming(15,8)+Hamming(8,10)+Hamming(10,14)+Hamming(14,12)

H(2)=Hamming(19,21)+Hamming(21,17)+Hamming(17,23)+Hamming(23,16)+Hamming(16,18)+Hamming(18,22)+Hamming(22,20)

H(3)=Hamming(27,29)+Hamming(29,25)+Hamming(25,31)+Hamming(31,24)+Hamming(24,26)+Hamming(26,30)+Hamming(30,28)

H(4)=Hamming(35,37)+Hamming(37,33)+Hamming(33,39)+Hamming(39,32)+Hamming(32,34)+Hamming(34,38)+Hamming(38,36)

H(5)=Hamming(43,45)+Hamming(45,41)+Hamming(41,47)+Hamming(47,40)+Hamming(40,42)+Hamming(42,46)+Hamming(46,44)

H(6)=Hamming(51,53)+Hamming(53,49)+Hamming(49,55)+Hamming(55,48)+Hamming(48,50)+Hamming(50,54)+Hamming(54,52)

H(7)=Hamming(59,61)+Hamming(61,57)+Hamming(57,63)+Hamming(63,56)+Hamming(56,58)+Hamming(58,62)+Hamming(62,60)

Accordingly, the operation rate A related to the twiddle coefficient W(n) can be obtained from the sum total P of the hamming distances related to the twiddle coefficient W(n) through the following.

A=P=H(0)+H(1)+H(2)+H(3)+H(4)+H(5)+H(6)+H(7)

The FFT frame interleave power optimization bit-reverse order according to the present example embodiment is the order selected from a plurality of FFT frame interleave bit-reverse order candidates that can minimize the operation rate A related to the twiddle coefficient W(n). In other words, the FFT frame interleave power optimization bit-reverse order according to the present example embodiment can be regarded as the order among a plurality of FFT frame interleave bit-reverse order candidates that leads to the smallest power consumption related to the twiddle coefficient table 31a that outputs the twiddle coefficient W(n).

Meanwhile, the twiddle multiplication unit 31b constituting the twiddle multiplication processing unit 31 is affected by, in addition to the operation rate of the twiddle coefficient W(n), the operation rate of y(n) that the second data sorting processing unit 12 outputs, but since the FFT device 10 receives an input of desired data, the operation rate of y(n) conceivably remains constant in the long term regardless of the order in which y(n) is output. In a similar manner, as for the data sorting processing units or the butterfly computation processing units constituting the FFT device 10, since the FFT device 10 receives an input of desired data, the operation rate of these processing units conceivably remains constant in the long term regardless of the order of the processes. Accordingly, the FFT frame interleave power optimization bit-reverse order according to the present example embodiment can be regarded as the order among a plurality of FFT frame interleave bit-reverse order candidates that can minimize the power consumption of the FFT device 10.

As described above, according to the present example embodiment as well, the FFT device 10 can output data in a desired order by specifying the order with use of the output order setting 52. For example, in a plurality of FFT processes performed consecutively, the power related to a twiddle computation process or a filter computation process can be reduced through an interleaved processing order. As a result, the power consumption in the overall digital filtering process can be reduced.

In the case described according to the present example embodiment, a 64-point FFT process (N=64) is performed in eight cycles (M=N/P=8) with eight data items processed in parallel (P=8). The number of points in an FFT process, however, is not limited to 64. The present example embodiment may be applied in a similar manner with any integer N of 2 or higher. Moreover, the number of data items processed in parallel is not limited to eight, and the process may be performed with P data items in parallel, where P is any integer of N or lower. In this case, a single N-point FFT process is performed in C=N/P cycles.

In the case described as an example according to the present example embodiment, the processing order of the four FFT processes performed consecutively is interleaved. The number of the FFT processes to be interleaved, however, is not limited to four. The processing order of F FFT processes performed consecutively may be interleaved, where F is any integer of 2 or higher. In this case, the operation rate related to the twiddle coefficient W(n) or the filter coefficient C(k) can be reduced to 1/F, and the power related to the twiddle computation process or the filter computation process can be reduced accordingly.

Furthermore, according to the present example embodiment, the processes are performed in the order that can minimize the power related to the twiddle multiplication process. As a result, the power consumption in the entire FFT processes can be reduced.

While an FFT process is described as an example according to the present example embodiment, the description applies in a similar manner in IFFT as well. Specifically, if the processing order within an IFFT process or in a stage that follows an IFFT process is optimized by applying the control method according to the present example embodiment to an IFFT processing device, the power consumption in the IFFT process or in the stage that follows the IFFT process can be reduced.

In the foregoing example embodiments, the present disclosure has been described as a hardware configuration, but the present disclosure is not limited thereto. The present disclosure can also be implemented by causing a central processing unit (CPU) to execute a computer program for the processing procedures shown in flowcharts and the processing procedures described in other example embodiments.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The present disclosure can provide a fast Fourier transform device, a digital filtering device, a fast Fourier transform method, and a program that enable a reduced power-consumption circuit implementing digital signal processing with use of fast Fourier transform.

It is to be noted that the present disclosure is not limited to the foregoing example embodiments, and modifications can be made, as appropriate, within the scope that does not depart from the technical spirit.

The first, second, and third embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A fast Fourier transform device configured to perform, on input time-domain input data, a fast Fourier transform or an inverse fast Fourier transform in M cycles (M is a positive integer of 2 or higher) in units of N consecutive input data (N is a positive integer of 2 or higher), the fast Fourier transform device comprising:
in F fast Fourier transforms or F inverse fast Fourier transforms (F is a positive integer of 2 or higher) processed consecutively,
first data sorting processing unit configured to sort (F×N) first input data that are input in a first order to output first output data in a second order;
butterfly computation processing unit configured to perform a butterfly computation process on the first output data to output second output data in the first order;
second data sorting processing unit configured to sort the second output data to output third output data in a third order; and
twiddle multiplication processing unit configured to perform a twiddle multiplication process by multiplying the third output data by a twiddle coefficient to output fourth output data in the third order,
wherein the third order is an order in which processes of a Cth cycle (C is an integer satisfying 0≤C≤M−1) in the F fast Fourier transforms or the F inverse fast Fourier transforms processed consecutively are performed in a consecutive cycle.

2. The fast Fourier transform device according to claim 1, wherein the twiddle multiplication processing unit is configured to perform the twiddle multiplication process by outputting the twiddle coefficient in the third order to the third output data, the third order being an order in which a bit transition rate between consecutive cycles of the twiddle coefficient is small.

3. The fast Fourier transform device according to claim 1, wherein
the second data sorting processing unit includes
storage unit configured to store (M×N) second output data, and
readout address generating unit configured to generate a readout address of (F×N) third output data to be read out from the storage unit, based on an output order setting, and
the second data sorting processing unit is configured to store a plurality of the second output data in the second order and read out the plurality of second output data in the third order.

4. A digital filtering device comprising:
the fast Fourier transform device according to claim 1; and
filtering processing unit configured to perform a filtering multiplication process by outputting a filter coefficient in the third order to output data that the fast Fourier transform device outputs in the third order.

5. A fast Fourier transform method performed by a fast Fourier transform device configured to perform, on input time-domain input data, a fast Fourier transform or an inverse fast Fourier transform in M cycles (M is a positive integer of 2 or higher) in units of N consecutive input data (N is a positive integer of 2 or higher), the fast Fourier transform method comprising:
in F fast Fourier transforms or F inverse fast Fourier transforms (F is a positive integer of 2 or higher) processed consecutively,
sorting (F×N) first input data that are input in a first order to output first output data in a second order;
performing a butterfly computation process on the first output data to output second output data in the first order;
sorting the second output data to output third output data in a third order; and
performing a twiddle multiplication process by multiplying the third output data by a twiddle coefficient to output fourth output data in the third order,
wherein the third order is an order in which processes of a Cth cycle (C is an integer satisfying 0≤C≤M−1) in the F fast Fourier transforms or the F inverse fast Fourier transforms processed consecutively are performed in a consecutive cycle.

6. The fast Fourier transform method according to claim 5, wherein in the twiddle multiplication process, the fast Fourier transform device performs the twiddle multiplication process by outputting the twiddle coefficient in the third order to the third output data, the third order being an order in which a bit transition rate between consecutive cycles of the twiddle coefficient is small.

7. The fast Fourier transform method according to claim 5, wherein in the second data sorting process, the fast Fourier transform device
stores (M×N) second output data,
generates a readout address of (F×N) third output data from the (M×N) second output data, based on an output order setting, and
stores a plurality of the second output data in the second order and reads out the plurality of second output data in the third order.

8. A non-transitory computer-readable medium storing a program that causes a fast Fourier transform device configured to perform, on input time-domain input data, a fast Fourier transform or an inverse fast Fourier transform in M cycles (M is a positive integer of 2 or higher) in units of N consecutive input data (N is a positive integer of 2 or higher) to execute:
in F fast Fourier transforms or F inverse fast Fourier transforms (F is a positive integer of 2 or higher) processed consecutively,
a process of sorting (F×N) first input data that are input in a first order to output first output data in a second order;
a process of performing a butterfly computation process on the first output data to output second output data in the first order;
a process of sorting the second output data to output third output data in a third order; and
a process of performing a twiddle multiplication process by multiplying the third output data by a twiddle coefficient to output fourth output data in the third order,
wherein the third order is an order in which processes of a Cth cycle (C is an integer satisfying 0≤C≤M−1) in the F fast Fourier transforms or the F inverse fast Fourier transforms processed consecutively are performed in a consecutive cycle.

9. The non-transitory computer-readable medium storing a program according to claim 8, wherein in the twiddle multiplication process, the fast Fourier transform device is caused to execute the twiddle multiplication process by outputting the twiddle coefficient in the third order to the third output data, the third order being an order in which a bit transition rate between consecutive cycles of the twiddle coefficient is small.

10. The non-transitory computer-readable medium storing a program according to claim 8, wherein in the second data sorting process, the fast Fourier transform device is caused to execute
a process of storing (M×N) second output data,
a process of generating a readout address of (F×N) third output data from the (M×N) second output data, based on an output order setting, and
a process of storing a plurality of the second output data in the second order and reading out the plurality of second output data in the third order.
